(19) United States
(12) Patent Application Publication
(10) Pub. No.: US 2021/0312544 A1
(43) Pub. Date: Oct. 7, 2021

(54) INFORMATION PROCESSING APPARATUS, INFORMATION PROCESSING PROGRAM, AND INFORMATION PROCESSING SYSTEM

(71) Applicant: TOYOTA JIDOSHA KABUSHIKI KAISHA, Toyota-shi (JP)

(72) Inventors: Kazuyuki INOUE, Nagoya-shi (JP); Kuniaki JINNAI, Nagoya-shi (JP); Kenichiro FUJIMORI, Tokyo (JP); Kohei TSUDA, Tokyo (JP); Noriaki MOCHIDA, Nagoya-shi (JP); Shuhei OCHIAI, Nagoya-shi (JP); Satoru SAKAMOTO, Tokyo (JP); Masashi KAMAKURA, Ichikawa-shi (JP)

(73) Assignee: TOYOTA JIDOSHA KABUSHIKI KAISHA, Toyota-shi (JP)

(21) Appl. No.: 17/214,004

(22) Filed: Mar. 26, 2021

(30) Foreign Application Priority Data
Apr. 6, 2020 (JP) 2020-068464

(51) Int. Cl. G06Q 40/02

(52) U.S. Cl. CPC G06Q 40/025

(57) ABSTRACT

An information processing apparatus includes a processor having hardware. The processor is configured to calculate a total score of a borrower who desires to use a lending service, based on a use record score determined by a use record of the borrower in the lending service and a credibility score determined by a payment record of each settlement means, output the total score of the borrower to a terminal of the lender, and output a lending permission and inhibition result to a terminal of the borrower according to response information acquired from the terminal of the lender.

### CROSS-REFERENCE TO RELATED APPLICATION

This application claims priority to Japanese Patent Application No. 2020-068464 filed on Apr. 6, 2020, incorporated herein by reference in its entirety.

### BACKGROUND

### 1. Technical Field

The present disclosure relates to an information processing apparatus, an information processing program, and an information processing system.

### 2. Description of Related Art

Japanese Unexamined Patent Application Publication No. 2019-135587 (JP 2019-135587 A) and Japanese Unexamined Patent Application Publication No. 2019-61586 (JP 2019-61586 A) disclose a technique that evaluates driving of a user based on vehicle traveling information of the user in a car sharing service.

### SUMMARY

In providing a lending service, such as a car sharing service, a lender has a risk of lending to an unreliable borrower.

The present disclosure has been accomplished in view of the above description, and provides an information processing apparatus, an information processing program, and an information processing system capable of reducing a risk of a lender in a lending service.

A first aspect of the present disclosure relates to an information processing apparatus including a processor having hardware. The processor is configured to calculate a total score of a borrower who desires to use a lending service, based on a use record score determined by a use record of the borrower in the lending service and a credibility score determined by a payment record of each settlement means, output the total score of the borrower to a terminal of a lender, and output a lending permission and inhibition result to a terminal of the borrower according to response information acquired from the terminal of the lender.

A second aspect of the present disclosure relates to an information processing program. The information processing program causing a processor having hardware to execute calculating a total score of a borrower who desires to use a lending service, based on a use record score determined by a use record of the borrower in the lending service and a credibility score determined by a payment record of each settlement means, outputting the total score of the borrower to a terminal of a lender, and outputting a lending permission and inhibition result to a terminal of the borrower according to response information acquired from the terminal of the lender.

A third aspect of the present disclosure relates to an information processing system including a first terminal, a second terminal, and an information processing apparatus. The first terminal includes a first processor having hardware, and a display. The second terminal includes a second processor having hardware, and a display. The information processing apparatus includes a third processor having hardware. The third processor is configured to calculate a total score of a borrower who desires to use a lending service, based on a use record score determined by a use record of the borrower in the lending service and a credibility score determined by a payment record of each settlement means, output the total score of the borrower to a terminal of a lender, and output a lending permission and inhibition result to a terminal of the borrower according to response information acquired from the terminal of the lender.

According to the aspects of the present disclosure, it is possible to reduce a risk of a lender in a lending service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of a wallet system according to an embodiment;

FIG. 2 is a block diagram schematically showing the configuration of a wallet server according to the embodiment;

FIG. 3 is a block diagram schematically showing the configuration of a settlement service provider server according to the embodiment;

FIG. 4 is a block diagram schematically showing the configuration of a user terminal according to the embodiment;

FIG. 5 is a diagram schematically showing a relationship of payment means, deposit means, and settlement means in the wallet system according to the embodiment;

FIG. 6 is a block diagram schematically showing the configuration of a vehicle according to the embodiment;

FIG. 7 is a block diagram schematically showing the configuration of a use record management server according to the embodiment;

FIG. 8 is a block diagram schematically showing the configuration of a credibility evaluation server according to the embodiment;

FIG. 9 is a schematic view illustrating a credibility evaluation method according to the embodiment; and

FIG. 10 is a flowchart illustrating lending mediation processing that is executed by the wallet server according to the embodiment.

### DETAILED DESCRIPTION OF EMBODIMENTS

Hereinafter, an embodiment of the present disclosure will be described referring to the drawings. In all drawings of the embodiment described below, the same or corresponding portions are represented by the same reference signs. The present disclosure is not limited to the embodiment described below.

Wallet System

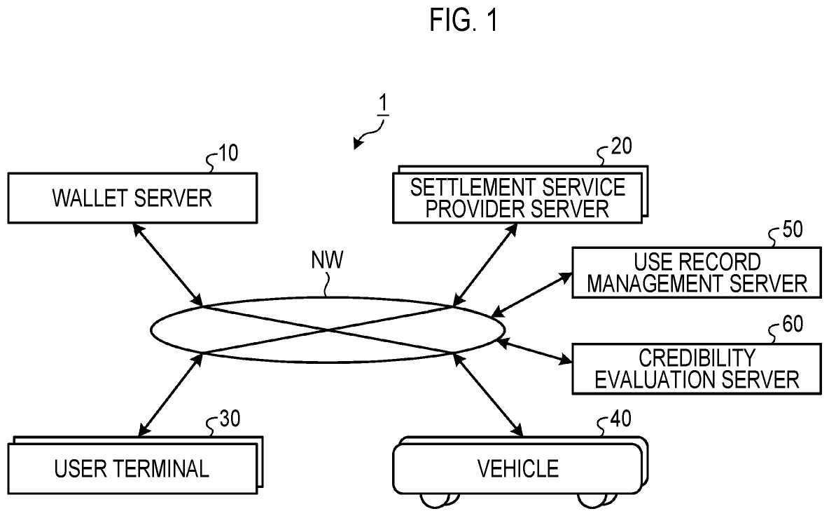

A wallet system according to the embodiment of the present disclosure to which an information processing apparatus can be applied will be described referring to the drawings. FIG. 1 is a diagram schematically showing the configuration of the wallet system according to the embodiment. As shown in FIG. 1, a wallet system 1 according to the embodiment has a wallet server 10, a settlement service provider server 20, a user terminal 30, a vehicle 40, a use record management server 50, and a credibility evaluation server 60 that can perform communication with one another through a network NW.

The network NW is constituted of an Internet network, a mobile phone network, or the like. The network NW is, for example, a public communication network, such as the Internet, and may include other communication networks, such as a wide area network (WAN), a telephone communication network of a mobile phone or the like, and a wireless communication network, such as WiFi (Registered Trademark).

Wallet Server

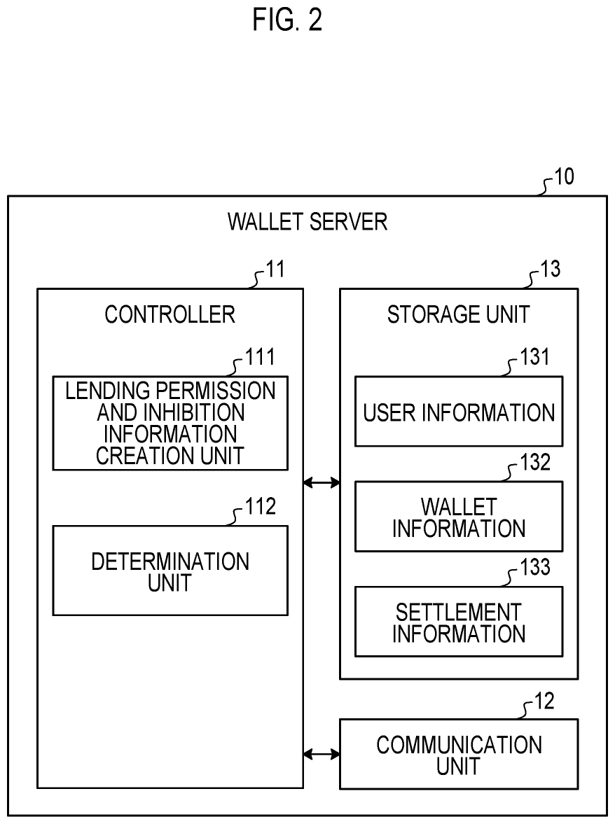

FIG. 2 is a block diagram schematically showing the configuration of the wallet server according to the embodiment. The wallet server 10 as a first server including an information processing apparatus is a server that integrally manages the wallet system according to the embodiment, and is managed by a manager of the wallet system. As shown in FIG. 2, the wallet server 10 includes a controller 11 as a first processor, a communication unit 12, and a storage unit 13.

The controller 11 specifically includes a processor having hardware, such as a central processing unit (CPU), a digital signal processor (DSP), or a field-programmable gate array (FPGA), and a main storage unit, such as a random access memory (RAM) or a read only memory (ROM). The storage unit 13 is constituted of a storage medium selected from an erasable programmable ROM (EPROM), a hard disk drive (HDD), and a removable medium. Examples of the removable medium include disc recording mediums, such as a universal serial bus (USB) memory, a compact disc (CD), a digital versatile disc (DVD), and Blu-ray disc (BD) (Registered Trademark). In the storage unit 13, an operating system (OS), various programs, various tables, various databases, and the like can be stored. The controller 11 loads programs stored in the storage unit 13 on a work area of the main storage unit and executes the programs, thereby controlling the components and the like through the execution of the programs. A program may be a learned model generated by, for example, machine learning, such as deep learning. With this, the controller 11 can realize functions of a lending permission and inhibition information creation unit 111 and a determination unit 112. Details of the functions of the lending permission and inhibition information creation unit 111 and the determination unit 112 will be described below.

The communication unit 12 is constituted of, for example, a local area network (LAN) interface board or a wireless communication circuit for wireless communication. The LAN interface board and the wireless communication circuit are connected to the network NW, such as the Internet that is a public communication network. The communication unit 12 is connected to the network NW to perform communication with the settlement service provider server 20, the user terminal 30, the vehicle 40, the use record management server 50, and the credibility evaluation server 60.

In the storage unit 13 according to the embodiment, user information 131, wallet information 132, and settlement information 133 for each user wallet system are stored. In the storage unit 13, a program for executing lending mediation processing described below or the like is stored.

The user information 131 is information regarding a user who uses the wallet system. Examples of the user information 131 include a user ID of a user who performs use registration of the wallet system, a password, a name of the user, a place to contact of the user (for example, an address, a telephone number, and a mail address), a use registration history, information regarding payment means registered as deposit means, information regarding payment means registered as settlement means, and a personal identification number at the time of settlement. The user ID and the password in the user information 131 are used for authentication processing, such as login to the wallet server 10.

The wallet information 132 is information regarding a wallet of the wallet system. The wallet indicates a virtual deposit and withdrawal account of electronic money. Examples of the wallet information 132 include the user ID, a balance of electronic money, a deposit history of electronic money, and a use history of electronic money.

The settlement information 133 is information regarding settlement of the wallet system. Examples of the settlement information 133 include the user ID, settlement means (for example, electronic money payment (noncontact settlement), scan payment, code payment, or the like) used in settlement, and a settlement history.

Settlement Service Provider Server

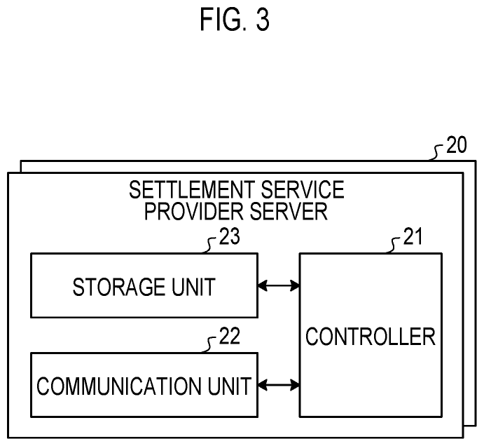

FIG. 3 is a block diagram schematically showing the configuration of the settlement service provider server according to the embodiment of the present disclosure. The settlement service provider server 20 is a server that manages an account and a credit card of the user, and is provided in a banking institution (for example, a bank, a credit union, a credit association, or a labor credit association) and a credit card company. As shown in FIG. 3, the settlement service provider server 20 includes a controller 21, a communication unit 22, and a storage unit 23. The controller 21, the communication unit 22, and the storage unit 23 are physically the same as the controller 11, the communication unit 12, and the storage unit 13, respectively.

In the storage unit 23, account information and credit card information for each user of the wallet system are stored. Examples of the account information include the name of the user, an account number, an account balance, and a deposit and withdrawal history. Examples of the credit card information include the name of the user, a credit card number, an expiration date of a credit card, a use limit amount, and a card use history.

User Terminal

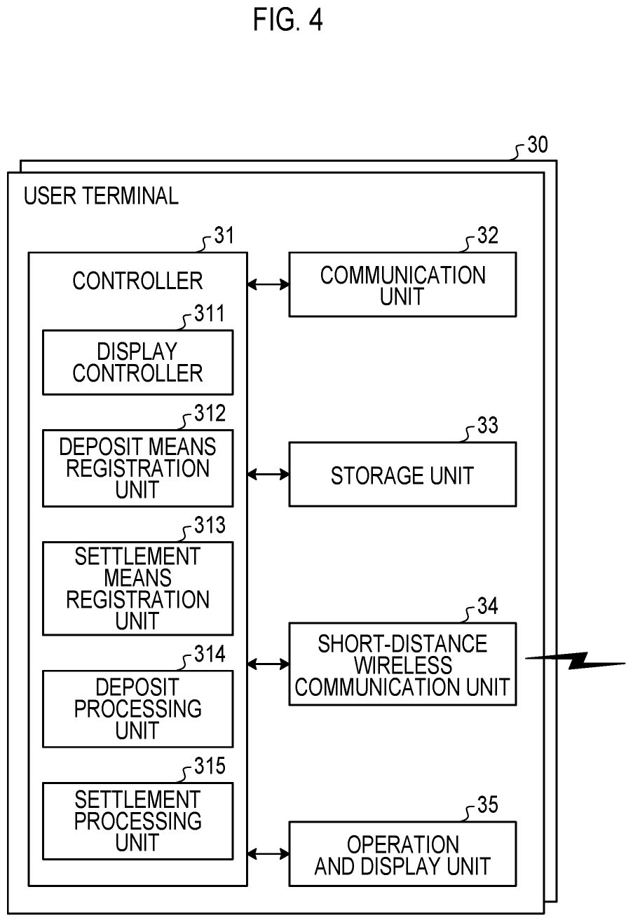

FIG. 4 is a block diagram schematically showing the configuration of the user terminal according to the embodiment of the present disclosure. The user terminal 30 is a computer terminal that is used by the user. Examples of the user terminal 30 include a smartphone, a mobile phone, a tablet terminal, a wearable computer, or a personal computer, a car navigation device mounted in a vehicle, and the like that is owned by the user. The user terminal 30 may be any terminal as long as the terminal can exchange information with the wallet server 10.

As shown in FIG. 4, the user terminal 30 includes a controller 31 as a second processor, a communication unit 32, a storage unit 33, a short-distance wireless communication unit 34, and an operation and display unit 35. The controller 31, the communication unit 32, and the storage unit 33 are physically the same as the controller 11, the communication unit 12, and the storage unit 13, respectively. The controller 31 functions as the display controller 311, the deposit means registration unit 312, the settlement means registration unit 313, the deposit processing unit 314, and the settlement processing unit 315 through the execution of the programs.

The display controller 311 controls display contents on the operation and display unit 35. The display controller 311 displays, on the operation and display unit 35, a member registration screen when the user performs member registration, a login screen when the user logs in to the wallet system, a deposit screen when the user deposits electronic money in the wallet, a settlement screen when settlement is performed, a use history screen on which a list of use history, such as settlement, is displayed, a payment history detailed screen on which details of a payment history are displayed, a code payment screen, a scan payment screen, and the like based on a user's operation (touch operation, flick operation, or the like). The display controller 311 transits each screen based on a user's operation. The display controller 311 displays a screen pertaining to lending of the vehicle 40 or the like. In regard to a screen configuration of the settlement screen, the use history screen, the payment history detailed screen, the code payment screen, and the screen pertaining to lending of the vehicle 40 or the like, various configurations can be employed.

The deposit means registration unit 312 registers deposit means for depositing electronic money. Specifically, the deposit means registration unit 312 outputs a deposit means registration request for registering a plurality of different payment means (for example, bank account, credit card, virtual credit card, and the like) to be operated by a plurality of service providers as deposit means in the wallet and transmits the deposit means registration request to the wallet server 10. Hereinafter, processing of outputting and transmitting to a target is simply referred to as “transmit”. The controller 11 of the wallet server 10 that receives the deposit means registration request from the deposit means registration unit 312 registers the payment means included in the deposit means registration request as the deposit means by storing the payment means as the user information 131 in the storage unit 13.

The deposit means registration unit 312 also registers, as deposit means, payment means that is registered as settlement means. That is, when a settlement means registration request is transmitted from the settlement means registration unit 313 to the wallet server 10, the deposit means registration unit 312 transmits a deposit means registration request for registering payment means included in the settlement means registration request as settlement means to the wallet server 10. The controller 11 of the wallet server 10 that receives the deposit means registration request from the deposit means registration unit 312 registers the payment means included in the deposit means registration request as the deposit means by storing the payment means as the user information 131 in the storage unit 13.

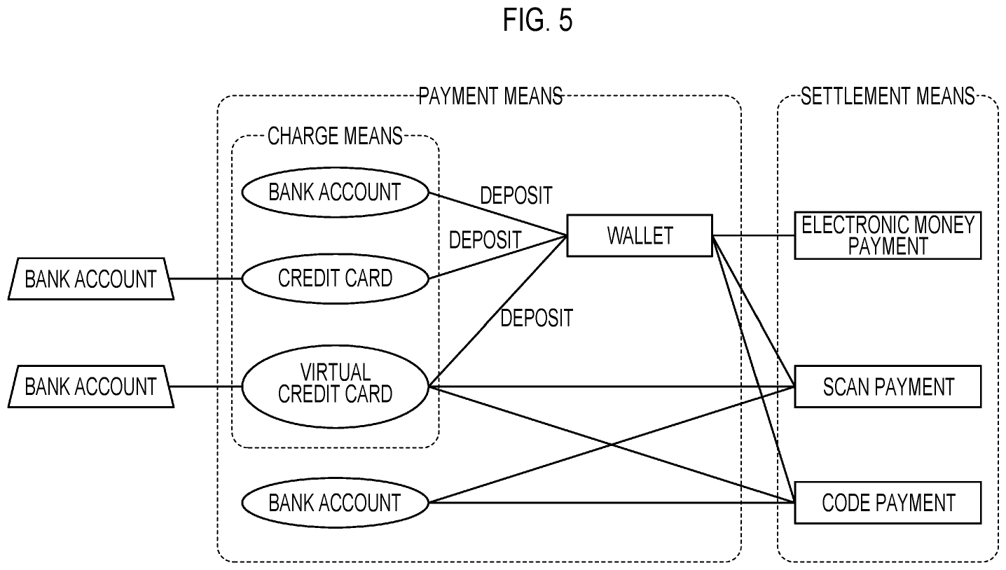

Here, FIG. 5 is a diagram schematically showing a relationship of payment means, charge means, and settlement means in the wallet system according to the embodiment. The “payment means” indicates means to be a payment resource (funding source) when settlement is performed. As the payment means, a bank account, a credit card, a virtual credit card, and a balance of electronic money in the wallet are included. The virtual credit card is an intangible credit card, and is constituted of, for example, information regarding a card number, an expiration date, and an authentication number (security code). A bank account is associated with each of the credit card and the virtual credit card, and a used amount of each card is withdrawn from the bank account later.

The “charge means” indicates means for depositing electronic money in the wallet that is a virtual deposit and withdrawal account. As the charge means, a bank account, a credit card, and a virtual credit card among the payment means are included. The bank account, the credit card, and the virtual credit card are registered as the charge means, whereby it is possible to deposit electronic money in the wallet.

The “settlement means” indicates a method that performs settlement using the payment means. The settlement means includes electronic money payment, scan payment, and code payment. The electronic money payment is, for example, settlement that is performed in a noncontact manner between the short-distance wireless communication unit 34 of the user terminal 30 and a short-distance wireless communication unit of a terminal in a store or the like by the user holding the user terminal 30 up to the terminal in the store or the like. The scan payment is settlement that is performed by reading a barcode or a QR code (Registered Trademark) displayed on the terminal in the store or the like with a camera or the like of the user terminal 30. The code payment is settlement that is performed by reading a barcode or a QR code (Registered Trademark) displayed on the user terminal 30 with a code reader or the like of the terminal in the store or the like.

In the wallet system according to the embodiment, it is possible to use all three kinds of settlement means using three kinds of payment means. That is, in the wallet system, it is possible to combine the payment means and the settlement means as (1) to (3) described below.

(1) The electronic money payment, the scan payment, and the code payment using the balance of electronic money in the wallet

(2) The electronic money payment, the scan payment, and the code payment using the virtual credit card

(3) The electronic money payment, the scan payment, and the code payment using the bank account

In this way, in the wallet system according to the embodiment, it is possible to deposit electronic money in the wallet through a plurality of payment means and to settle the balance of electronic money deposited in the wallet through a plurality of settlement means.

Returning to FIG. 4, the settlement means registration unit 313 also registers, as settlement means, the payment means that is registered as the deposit means. That is, when the deposit means registration request is transmitted from the deposit means registration unit 312 to the wallet server 10, the settlement means registration unit 313 transmits a settlement means registration request for registering the payment means included in the deposit means registration request as settlement means to the wallet server 10.

For example, when registering certain payment means (a bank account of an A bank) as deposit means, the settlement means registration unit 313 also automatically registers the payment means (the bank account of the A bank) as settlement means. “The payment means is registered as the settlement means” means that settlement can be performed using the payment means as a payment source, and means that the electronic money payment, the scan payment, and the code payment are enabled, for example, using the bank account of the A bank as a payment source. The controller 11 of the wallet server 10 that receives the settlement means registration request from the settlement means registration unit 313 registers the payment means included in the settlement means registration request as the settlement means by storing the payment means as the user information 131 in the storage unit 13.

The deposit processing unit 314 deposits electronic money in the wallet. Specifically, the deposit processing unit 314 transmits a deposit request for depositing electronic money in the wallet through the payment means registered as the deposit means to the wallet server 10. The controller 11 of the wallet server 10 that receives the deposit request from the deposit processing unit 314 increases the balance of electronic money in the wallet based on deposit amount information included in the deposit request. That is, the controller 11 updates the wallet information 132 stored in the storage unit 13 according to an increased amount of the balance of electronic money in the wallet.

The settlement processing unit 315 performs settlement with the payment means. The settlement processing unit 315 transmits a settlement request for performing settlement with electronic money deposited in the wallet using any one of a plurality of settlement means (electronic money payment, scan payment, and code payment) set in advance to the wallet server 10. For example, when performing the electronic money payment, the settlement processing unit 315 transmits the settlement request to the wallet server 10 through the network NW. When performing the scan payment, the settlement processing unit 315 transmits the settlement request to the wallet server 10 by reading a barcode or a QR code (Registered Trademark) displayed on the terminal in the store or the like with the camera or the like of the user terminal 30. When performing the code payment, the settlement processing unit 315 transmits the settlement request to the wallet server 10 by reading a barcode or a QR code (Registered Trademark) displayed on the user terminal 30 with a code reader or the like in the store or the like. In the settlement request that is transmitted from the settlement processing unit 315 to the wallet server 10, information (hereinafter, referred to as “settlement amount information”) indicating a settlement amount may be include or may not be included.

Subsequently, the controller 11 of the wallet server 10 that receives the settlement request decreases the balance of electronic money in the wallet based on the settlement amount information included in the settlement request. That is, the controller 11 updates the wallet information 132 and the settlement information 133 stored in the storage unit 13 according to a decreased amount of the balance of electronic money in the wallet.

The settlement processing unit 315 can also perform settlement using payment means (for example, a bank account or a credit card) other than the balance of electronic money in the wallet. In this case, the settlement processing unit 315 transmits a settlement request for performing settlement with the bank account or the credit card using any one of a plurality of settlement means to the wallet server 10. The controller 11 of the wallet server 10 that receives the settlement request from the settlement processing unit 315 transmits settlement amount information included in the settlement request to the settlement service provider server 20.

In the storage unit 33, data of various screens that are displayed on the operation and display unit 35 by the display controller 311 is stored. In the storage unit 33, the user information 131, the wallet information 132, the settlement information 133, and the like are stored continuously or temporarily as needed.

The short-distance wireless communication unit 34 has a communication function, for example, conforming to a standard, such as Near field radio communication (NFC), Bluetooth (Registered Trademark) Low Energy (BLE), or Infrared Data Association (IrDA). The user terminal 30 performs short-distance wireless communication with the terminal in the store or the like through the short-distance wireless communication unit 34, for example, when performing the electronic money payment.

The operation and display unit 35 is constituted of, for example, a touch panel display, and has an input function of receiving an operation with a finger of the user, a pen, or the like and a display function of displaying various kinds of information under the control of the display controller 311.

Vehicle

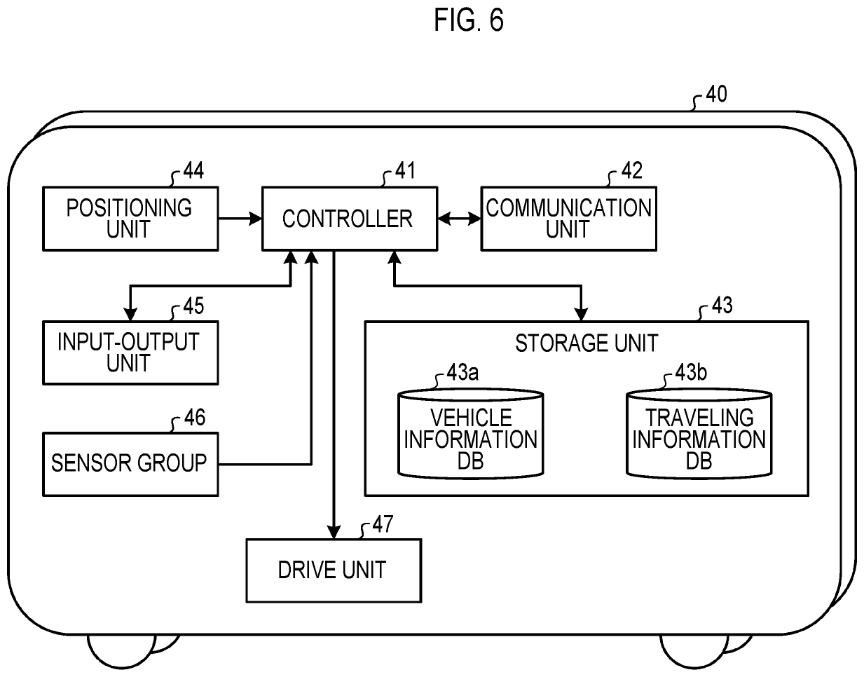

FIG. 6 is a block diagram schematically showing the configuration of the vehicle according to the embodiment of the present disclosure. The vehicle 40 as a moving object is a vehicle that travels with driving of a driver or an autonomous traveling vehicle configured to autonomously travel in compliance with a given traveling command. As shown in FIG. 6, the vehicle 40 includes controller 41, a communication unit 42, a storage unit 43, a positioning unit 44, an input-output unit 45, a sensor group 46, and a drive unit 47.

The controller 41, the communication unit 42, and the storage unit 43 are physically the same as the controller 11, the communication unit 12, and the storage unit 13, respectively. The controller 41 integrally controls the operation of each component mounted in the vehicle 40. The communication unit 42 as a communication terminal of the vehicle 40 is constituted of, for example, a data communication module (DCM) that performs communication with the wallet server 10 by wireless communication through the network NW.

The storage unit 43 includes a vehicle information database 43a and a traveling information database 43b. In the vehicle information database 43a, various kinds of information including an SOC, a remaining amount of fuel, vehicle dimension information, and the like are stored in an updatable manner. In the traveling information database 43b, various kinds of information including traveling information regarding a traveling route are stored in an updatable manner. The traveling information is information measured and generated by the controller 41 based on information obtained from the positioning unit 44 and the drive unit 47.

The positioning unit 44 receives radio waves from global positioning system (GPS) satellites to detect a position of the vehicle 40, for example. The position and the route of the vehicle 40 detected by the positioning unit 44 as a positional information acquisition unit of the vehicle 40 are stored as positional information or route information in the traveling information in a searchable manner in the vehicle information database 43a. As a method of detecting the position of the vehicle 40, a method in which light detection and ranging or laser imaging detection and ranging (LiDAR) and a three-dimensional digital map are combined may be employed.

The input-output unit 45 is constituted of a touch panel display, a speaker microphone, and the like. The input-output unit 45 as an output unit is configured to display text, a figure, or the like on a screen of the touch panel display or output sound from the speaker microphone to notify the outside predetermined information under the control of the controller 41. The input-output unit 45 as an input unit is configured to input predetermined information to the controller 41 when the user or the like operates the touch panel display or makes sound toward the speaker microphone.

The vehicle 40 according to the embodiment includes the positioning unit 44 and the input-output unit 45 as separate functions, but may include an in-vehicle navigation system with a communication function that has the functions of both of the positioning unit 44 and the input-output unit 45, instead of the positioning unit 44 and the input-output unit 45.

The drive unit 47 is a drive unit that performs drive needed for traveling of the vehicle 40. Specifically, the vehicle 40 includes an engine as a drive source, and the engine is configured to generate electric power using an electric motor or the like through drive by combustion of fuel. The generated electric power charges a chargeable battery. In addition, the vehicle 40 includes a drive transmission mechanism that transmits drive power of the engine, drive wheels for traveling, and the like.

In the vehicle 40, a short-distance wireless communication unit having a communication function conforming to, for example, a standard, such as NFC, BLE, or IrDA, may be provided.

Use Record Management Server

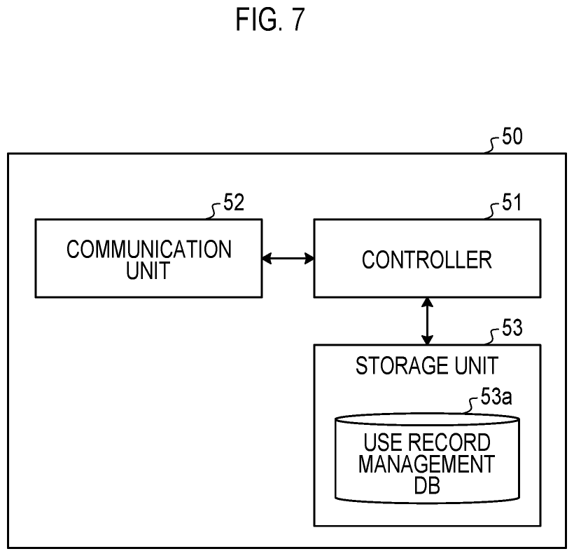

FIG. 7 is a block diagram schematically showing the configuration of the use record management server according to the embodiment. The use record management server 50 manages a record of traveling or the like of the vehicle 40. Various kinds of drive information or vehicle information is supplied from each vehicle 40 to the use record management server 50 at a predetermined timing. The drive information includes information regarding the drive of the vehicle 40, such as positional information, speed information, and acceleration information, but is not always limited to such information. The vehicle information includes information regarding the status of the vehicle 40, such as a state of charge (SOC) of a battery, a remaining amount of fuel, a current position, a vehicle interior status, and an exterior status, but is not always limited to such information.

The use record management server 50 has a configuration of a general computer that can perform communication through the network NW. The use record management server 50 includes a controller 51, a communication unit 52, and a storage unit 53 that stores a use record management database 53a.

The controller 51 is physically the same as the controller 11. The storage unit 53 is physically the same as the storage unit 13. The controller 51 loads programs stored in the storage unit 53 to a work area of the main storage unit, executes the programs, and controls the components through the execution of the programs, thereby realizing functions conforming to predetermined purposes.

The communication unit 52 is physically the same as the communication unit 12. The communication unit 52 is connected to the network NW to perform communication with the user terminal 30, the vehicle 40, and the credibility evaluation server 60. The communication unit 52 receives vehicle identification information unique to the vehicle 40 or drive status information from each vehicle 40 or transmits an instruction signal for the vehicle 40 to each vehicle 40. Note that the vehicle identification information includes information for individually identifying each vehicle 40. The communication unit 52 transmits information to the user terminal 30 owned by the user when the user uses the vehicle 40 or receives user identification information for identifying the user or various kinds of information from the user terminal 30.

The storage unit 53 includes the use record management database 53a that stores various pieces of data in a searchable manner. The use record management database 53a is, for example, a relational database (RDB). Note that a database (DB) described below is constructed by a program of a database management system (DBMS) to be executed by a processor managing data stored in the storage unit 53. In the use record management database 53a, the user identification information, various kinds of information (hereinafter, also referred to as user selection information) input or selected by the user to use the vehicle 40, and the like are stored in association with one another in a searchable manner. Furthermore, in the use record management database 53a, the vehicle identification information, the drive information, and the like are stored in association with one another in a searchable manner.

The user identification information and the vehicle identification information are stored in the use record management database 53a in a searchable state when the user identification information and the vehicle identification information are assigned to the user and the vehicle 40, respectively. The user identification information includes various kinds of information for identifying each user. The user identification information is, for example, a user ID or the like capable of identifying each user, and is registered in association with information unique to the user, such as a name or an address of the user, or positional information, such as a longitude and a latitude, representing a position or the like of the user. That is, the user identification information includes information needed to access the use record management server 50 at the time of transmission of information about the user. For example, in a case where the user terminal 30 transmits predetermined information, such as the user selection information, to the use record management server 50 along with the user identification information, the use record management server 50 stores the predetermined information in the use record management database 53a in the storage unit 53 in association with the user identification information in a searchable state. Similarly, the vehicle identification information includes various kinds of information for identifying each vehicle 40. In a case where the vehicle 40 transmits predetermined information, such as the positional information or the vehicle information, to the use record management server 50 along with the vehicle identification information, the use record management server 50 stores the predetermined information in the use record management database 53a in association with the vehicle identification information in a searchable state.

Credibility Evaluation Server

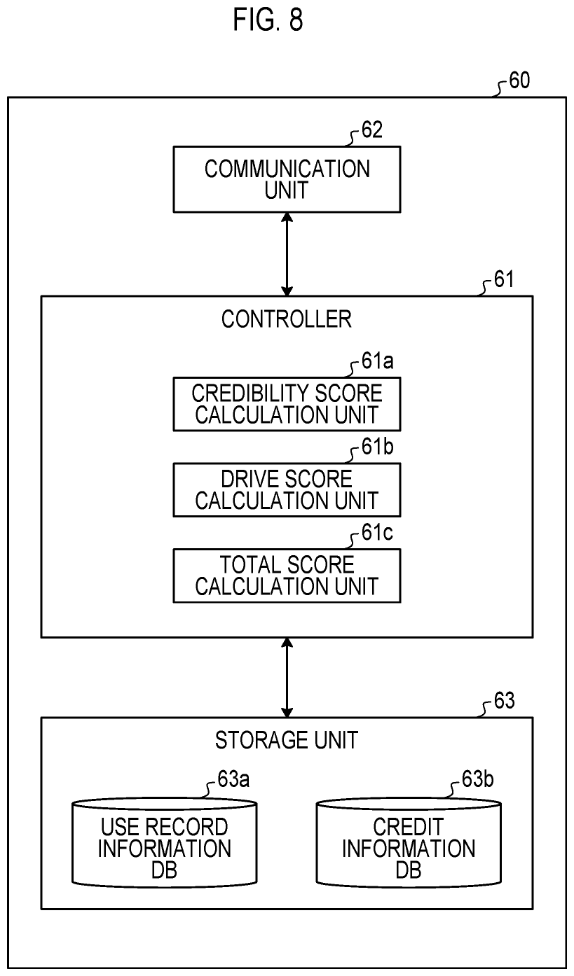

FIG. 8 is a block diagram schematically showing the configuration of the credibility evaluation server according to the embodiment. The credibility evaluation server 60 as a credibility evaluation device executes calculation processing of a degree of credibility of the user who uses the vehicle 40 as a structure having a communication function to execute evaluation processing of credibility. Various kinds of information (hereinafter, referred to as credibility evaluation information) need to evaluate the credibility of the user is supplied from the use record management server 50 to the credibility evaluation server 60.

The credibility evaluation server 60 has a configuration of a general computer that can perform communication through the network NW. The credibility evaluation server 60 includes a controller 61 having a credibility score calculation unit 61a, a drive score calculation unit 61b, and a total score calculation unit 61c, a communication unit 62, and a storage unit 63.

The communication unit 62 is configured similarly to the communication unit 12 and is connected to the network NW to perform communication with the wallet server 10 or the use record management server 50. Note that the communication unit 62 may be configured to perform communication with the vehicle 40 and the user terminal 30 as needed. The communication unit 62 transmits and receives at least a part of the user identification information, the user selection information, the vehicle information, and the drive information to and from the use record management server 50.

The controller 61 and the storage unit 63 are physically the same as the controller 11 and the storage unit 13, respectively. A use record information database 63a and a credit information database 63b are stored in the storage unit 63.

In the use record information database 63a, the user identification information and various kinds of information including credibility evaluation information of each user are stored in association with each other in a searchable manner.

Use record information regarding the user who uses the service provided by the vehicle 40 as a communicable structure includes structure information. The structure information includes use status information regarding the vehicle 40 while the user is using the service and structure status information indicating the status of the vehicle 40 after the users use the service. Note that evaluation information by users other than the user who uses the service may be included in the use record information. Examples of other users include a user who is an owner of the vehicle 40, other users who use the service provided by the vehicle 40, an employee of a management company that manages the vehicle 40, and a worker who cleans the vehicle 40. The evaluation information includes, for example, evaluation of the status (smell or the like) of the interior of the vehicle 40.

The use status information includes information regarding a driving behavior of the vehicle 40 or information regarding an activity of the user as a driver driving the vehicle 40. In the embodiment, specifically, the use status information includes information regarding a driving behavior of the vehicle 40 and information regarding an activity of the user driving, such as presence or absence or a frequency of distracted driving, presence or absence or a frequency of driving while operating a portable terminal device or the like (hereinafter, referred to as a terminal operation), or presence or absence or a degree of tailgating. Note that the use status information is not limited to such information.

The structure status information includes information regarding the status of the vehicle 40 after the user uses the service provided by the vehicle 40. Specifically, information regarding the status of the vehicle 40 includes information (hereinafter, referred to as vehicle interior information) regarding the status of the interior of the vehicle, such as scattered waste or arrangement of a tool or baggage after the user uses the service provided by the vehicle 40, and information (hereinafter, referred to as vehicle exterior information) regarding the status of the exterior of the vehicle 40. Information regarding the status of the vehicle 40 includes information (hereinafter, referred to as remaining fuel amount information) regarding a remaining amount of fuel, information (hereinafter, referred to as return position information) regarding a return position when the user returns the vehicle 40, and information (hereinafter, referred to as delay-related information), such as presence or absence of a delay with respect to a scheduled delivery time of the vehicle 40 by the user, a delay time, and presence or absence of delay notification. The structure information regarding the status of the vehicle 40 is not limited to such information. That is, when the user and another user directly perform delivery or the like of the vehicle 40, and when the user leaks personal information or the like of another user, information to the effect that the service is used against a rule on using the service can also be added to the structure status information.

In the credit information database 63b, the user identification information, information (credit information) regarding a credit transaction, such as a credit card or a loan of the user, and information, such as a use history of each settlement means, are stored in association with one another in a searchable manner. The credit information is also generally referred to as credibility information. The credit information database 63b is not limited as being provided in the credibility evaluation server 60. That is, the credit information database 63b may be provided in a server other than the credibility evaluation server 60, and access may be made to data of the credit information stored in another server through the network NW as needed.

The credit information is stored in the credit information database 63b in a searchable state and updated, for example, when the user performs a credit transaction or the like. The credit information is supplied from the settlement service provider server 20 or the use record management server 50 to the credibility evaluation server 60 and updated, for example, after the user uses the service provided by the vehicle 40 or after various kinds of settlement.

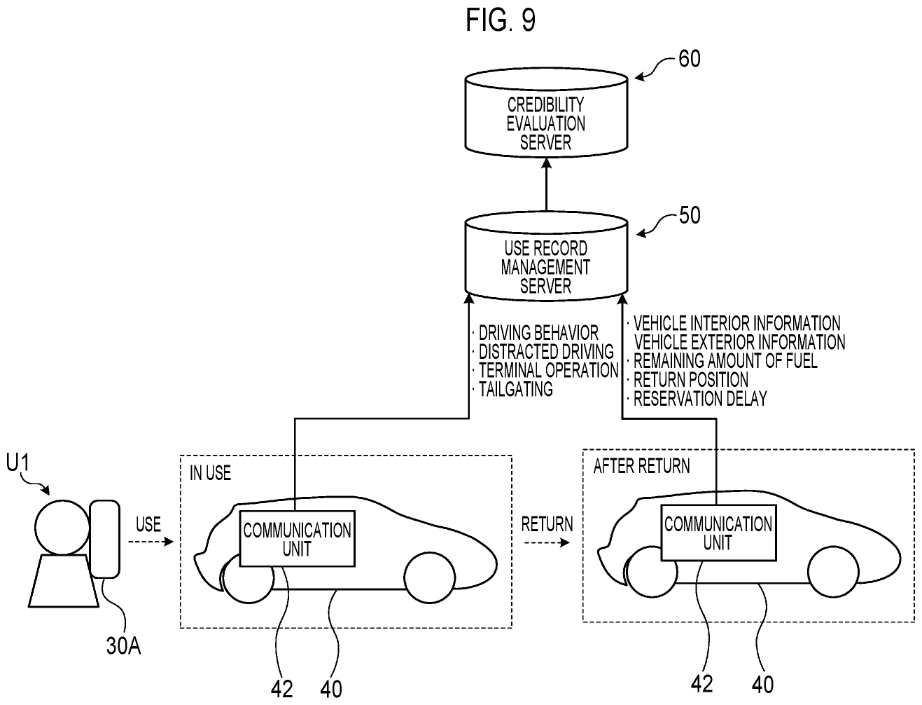

FIG. 9 is a schematic view illustrating a credibility evaluation method according to the embodiment. Hereinafter, a case where a car sharing service is used as the service will be described as an example. In the example, a case where a user Ul borrows and returns the vehicle 40 will be described. In the following description, transmission and reception of information are performed through the network NW, and description of this point on each occasion will be omitted.

The user Ul who carries a user terminal 30A borrows a predetermined vehicle 40 by a car sharing service. In this case, the user terminal 30A transmits user identification information of the user Ul and vehicle identification information of the vehicle 40, for example, to the use record management server 50 in association with each other. The use record management server 50 is, for example, a server of a provider that provides or mediates the car sharing service.

While the user Ul is using the service provided by the borrowed vehicle 40, the communication unit 52 of the vehicle 40 transmits the vehicle identification information and various kinds of information to the use record management server 50 at regular intervals. Various kinds of information in the embodiment are, for example, information regarding traveling of the vehicle 40 and driving of the user, and is specifically, the use status information, such as a driving behavior of the vehicle 40, the presence or absence and the frequency of distracted driving, the presence or absence and the frequency of the terminal operation, the presence or absence and the degree of tailgating. In addition, the communication unit 42 may supply the vehicle information of the vehicle 40 to the use record management server 50. The use record management server 50 stores various kinds of information supplied from the vehicle 40 in the use record management database 53a of the storage unit 53 in association with the vehicle identification information. The use record management server 50 supplies the use status information to the credibility evaluation server 60 in association with the user identification information of the user Ul. Here, when the user Ul is late for the time to deliver the vehicle 40 or does not transmit notification of the delay to a drive management server, information to the effect that the service is used against the rule on using the service is added to the delay-related information.

In a case where the user Ul ends the use of the service provided by the vehicle 40, the user Ul moves the vehicle 40 to a predetermined return position and returns the vehicle 40 based on a predetermined use rule in the car sharing service. Note that, when the user Ul returns the vehicle 40 at a place other than the predetermined return position, information to the effect that the service is used against the rule on using the service is added to the return position information. When a return time of the vehicle 40 by the user Ul is late for a scheduled time of return decided in advance, information to the effect that the service is used against the rule on using the service is added to the delay-related information. When the rule on using the service includes a rule to the effect that fuel at the time of returning the vehicle 40 is refilled to the same extent as that at the time of the start of use, and when the remaining amount of fuel is equal to or less than a predetermined percentage to the remaining amount of fuel at the time of the start of use, information to the effect that the service is used against the rule on using the service is added to the remaining fuel amount information.

After the vehicle 40 is returned, the communication unit 42 transmits various kinds of information, such as the vehicle interior information, the vehicle exterior information, the remaining fuel amount information, the return position information, and the delay-related information, measured or imaged by the sensor group 46 at the time of return as the structure status information to the use record management server 50.

Note that, when another user confirms the status of the vehicle 40 after the user Ul uses the vehicle 40 and evaluates the user Ul who previously uses the vehicle 40, information is transmitted as the evaluation information to the use record management server 50. The use record management server 50 transmits the supplied information to the credibility evaluation server 60 in association with the user identification information of the user Ul. Note that the structure status information and the evaluation information may be transmitted to the credibility evaluation server 60 further in association with the vehicle identification information.

The credibility evaluation server 60 calculates the degree of credibility of the user who uses the service provided by the vehicle 40 based on the supplied use status information, structure status information, and evaluation information to evaluate the credibility of the user.

Lending Mediation Method

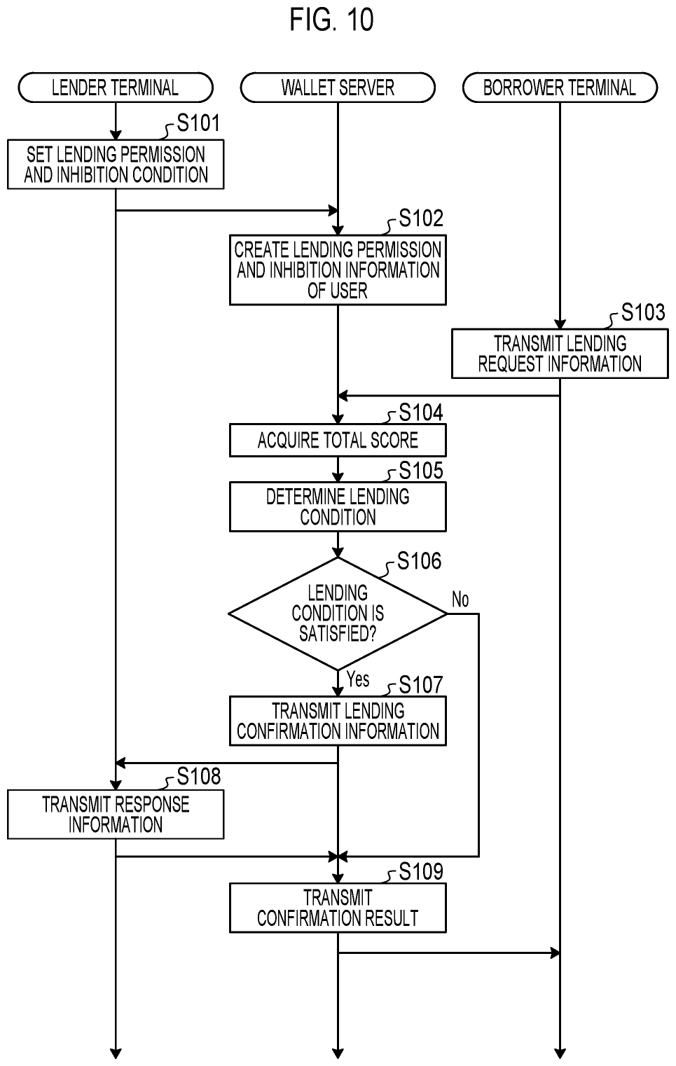

Next, a lending mediation method of the vehicle 40 by the wallet system 1 according to the embodiment configured as above will be described. FIG. 10 is a flowchart illustrating lending mediation processing that is executed by the wallet server according to the embodiment. In the lending mediation processing described below, the wallet server 10 mediates a lending contract between a lender terminal of a lender and a borrower terminal of a borrower. Each of the lender terminal and the borrower terminal has the configuration of the user terminal 30. The borrower terminal is, for example, the user terminal 30A (see FIG. 9).

The user who is a lender sets a lending permission and inhibition condition regarding permission and inhibition of lending on the vehicle 40 to be lent in the lender terminal (Step S101). Examples of the condition set herein include a condition for the credibility information of the borrower, such as a lower limit value of a total score, a credibility score, or a drive score described below. In the lending permission and inhibition condition, a different value for each settlement means can be set.

In the wallet server 10, in a case where setting information is input from the lender terminal, the lending permission and inhibition information creation unit 111 creates lending permission and inhibition information based on the input information and stores the lending permission and inhibition information in the user information 131 corresponding to the user identification information of the lender (Step S102).

Here, in a case where the borrower terminal transmits a lending request of the vehicle 40 to the wallet server 10 (Step S103), the controller 11 acquires a total score pertaining to credibility evaluation of the borrower from the credibility evaluation server 60 (Step S104).

Here, in the credibility evaluation server 60, the credibility score calculation unit 61a calculates a credibility score based on the credit information, the use history of each settlement means, and the like. Furthermore, the drive score calculation unit 61b calculates a drive score based on the use status information, the structure status information, or the like. The total score calculation unit 61c calculates the total score based on the credibility score and the drive score. The scores may be calculated after the lending request is transmitted or may be calculated and updated each time the use status information, the structure status information, or the like is updated.

The credibility score calculation unit 61a calculates the credibility score for each settlement means. The credibility score calculation unit 61a decides, for each settlement means, a first value that becomes greater as a use frequency or a used amount is greater and a second value that becomes greater as the degree of credibility is higher based on the credit information, and calculates the credibility score by adding or multiplying the first value and the second value. Note that, when the balance is different for each settlement means, the balance of each settlement means is reflected in the first value. For this reason, determination can be made that credibility is higher as the value of the credibility score is greater and settlement means having a greater value among settlement means is settlement means that is primarily used by the user. The degree of credibility herein is decided by the number of times of stagnation of settlement due to a shortage of the balance, the number of delay days from a stagnated date, or the like, and has a higher value as the number of times of stagnation and the number of delay days are smaller.

The drive score calculation unit 61b decides a third value that becomes greater as the evaluation of the use status information is higher and a fourth value that becomes greater as the evaluation of the structure status information is higher, and calculates the drive score by adding or multiplying the third value and the fourth value. For this reason, determination can be made that the credibility for the drive of the vehicle 40 or the use of the vehicle 40 is higher as the value of the drive score is greater. The drive score is re-calculated when the driving status of the borrower is improved. For example, when the use status information or the structure status information of the borrower is updated, and the evaluation becomes higher, the drive score calculation unit 61b may re-calculate the drive score of the borrower.

The total score calculation unit 61c calculates the total score by adding or multiplying the credibility score and the drive score. For this reason, determination can be made that the credibility as the borrower is higher as the value of the total score is greater.

Returning to FIG. 10, in a case where the total score of each settlement means is acquired, the determination unit 112 determines permission and inhibition of lending based on the lending permission and inhibition information of the lender (Step S105). The determination unit 112 compares a lower limit value of a score set as the lending permission and inhibition information with the acquired score to determine permission and inhibition of lending.

In this case, in a case where solely a lower limit value for the total score is set as the lending permission and inhibition information, the determination unit 112 compares the lower limit value with the total score of the borrower. In this case, in a case where the total score exceeds the lower limit value, the determination unit 112 determines that a lending condition is satisfied. On the other hand, in a case where the total score is equal to or less than the lower limit value, the determination unit 112 determines that the lending condition is not satisfied.

Furthermore, in a case where a lower limit value for each of the total score, the credibility score, and the drive score is set as the lending permission and inhibition information, the determination unit 112 compares the total score, the credibility score, and the drive score of the borrower with the respective lower limit values for each settlement means. In this case, in a case where there is settlement means where all of the total score, the credibility score, and the drive score exceed the lower limit values among the settlement means, the determination unit 112 determines that the lending condition is satisfied in the settlement means. On the other hand, in a case where at least one of the total score, the credibility score, and the drive score is equal to or less than the lower limit value, the determination unit 112 determines that the lending condition is not satisfied.

When the determination unit 112 determines that the lending condition is satisfied (Step S106: Yes), the controller 11 transits to Step S107. In contrast, when the determination unit 112 determines that the lending condition is not satisfied (Step S106: No), the controller 11 transits to Step S109.

In Step S107, the controller 11 transmits lending confirmation information to the lender terminal. The lending confirmation information is information that includes a request from the user satisfying the set lending permission and inhibition condition, and allows the lender to confirm whether or not to permit lending. In the lender terminal, information regarding the lending confirmation information is displayed by the operation and display unit 35. The lending confirmation information may include the score calculated in the credibility evaluation server 60. For example, in a case where there is a setting to include the total score in the lending confirmation information, the controller 11 transmits the lending confirmation information including the total score to the lender terminal. Furthermore, in a case where the score that is included in the lending confirmation information is set by the lender terminal, the controller 11 transmits the lending confirmation information including the score to the lender terminal.

The lender operates the lender terminal to transmit response information regarding whether or not to permit lending of the vehicle 40 to the wallet server 10 (Step S108). In this case, solely the lending confirmation information from the user (borrower) satisfying the condition set by the lender is transmitted to the lender, the lender cannot permit lending according to the status of the vehicle 40, or the like. Furthermore, the lender can determine permission and inhibition of lending based on an attribute of the borrower, such as a residential area or an age of the borrower. In addition, the lender can designate settlement means to be used at the time of present use among the settlement means set to the borrower with reference to the total score or the credibility score.

In Step S109, the controller 11 transmits a lending confirmation result of the vehicle 40 to the borrower terminal. When the response information of lending permission is acquired from the lender, the controller 11 creates, as the lending confirmation result, information to the effect that lending is permitted, and transmits the lending confirmation result to the borrower terminal. Thereafter, the controller 11 mediates a contract pertaining to lending of the vehicle 40. In this case, the wallet server 10 proceeds with a contract, such as a borrowing time of the vehicle 40 and setting of settlement by designated settlement means, between the lender and the borrower or transmits key information of the vehicle 40 to the borrower terminal. The key information includes, for example, operation permission information of the vehicle 40 that is valid for the borrowing time.

On the other hand, when the response information of lending inhibition is acquired from the lender, the controller 11 creates, as the lending confirmation result, information to the effect that lending is not permitted, and transmits the lending confirmation result to the borrower terminal.

With the lending mediation processing described above, lending processing of the vehicle 40 based on the score of the borrower is executed. Note that, when lending is inhibited, the controller 11 searches for a new request destination or the borrower requests lending of the vehicle 40 with another user.

Here, when there is a plurality of borrowers who requests to use the lending service and has at least a part of overlap among desired lending periods, the wallet server 10 selects a borrower who uses the lending service based on the total score of each borrower and the set lending permission and inhibition condition. In this case, for example, the wallet server 10 selects a borrower who has the highest total score or a borrower who has the credibility score or the drive score each satisfying the set value. Furthermore, the wallet server 10 may select a borrower who requests the longest lending period and has the total score equal to or greater than the lower limit value set in advance.

In addition, when a request to use the lending service is issued from the borrower, the wallet server 10 may extract a lender conforming to the set condition and may transmit the lending confirmation information to the extracted lender.

Note that, in the lending mediation processing, an example regarding lending of the vehicle 40 has been described; however, the lending processing includes sharing and rental. Furthermore, the lending processing is not limited to lending of the vehicle 40, and can be applied to processing of mediating lending of other articles or a contract of a service. For example, the lending processing can be applied to processing of mediating lending of a house, clothing, a trunk of a vehicle, equipment, or the like. For example, in a case of mediation of lending of a house, a score regarding a use record of a house is used instead of the drive score. The score is calculated, for example, based on an actual status of use, such as presence or absence of waste and damage, or term management, such as presence or absence of a delay of key return.

Furthermore, in the lending mediation processing, an insurance premium about lending of the vehicle 40 or an interest rate of divided payment, revolving payment, or the like may be decided based on the total score. For example, for the user who has a high total score, setting is made such that an insurance premium or an interest rate is inexpensive. In this case, the wallet server 10 is connected to a management server of an insurance company to perform setting of the insurance premium.

In the embodiment described above, determination regarding permission and inhibition of lending is performed in the wallet server 10 based on the lending permission and inhibition condition set by the lender, and even though the lending permission and inhibition condition is satisfied, the lending request of the vehicle 40 is established after final permission of the lender is transmitted. According to the embodiment, determination regarding permission and inhibition of lending can be performed based on the score of the borrower, such as the credit information, and thus, it is possible to reduce a risk of the lender in the lending service.

Furthermore, in the embodiment, the borrower can borrow the vehicle 40 more smoothly as the credibility score, the drive score, and the total score of the borrower are higher, and thus, the borrower takes an activity for increasing the credibility score and the drive score. As a result, for example, a delay of settlement, a shortage of the balance, or the like of the borrower is suppressed, and improvement of consciousness for safe driving of the borrower can be achieved.

Note that, in the embodiment, although an example where selection processing of the borrower is executed based on the total score or the like in the wallet server 10 has been described, when the request to use the lending service is issued from the borrower, the wallet server 10 may transmit the score, such as the total score, as the lending confirmation information to the lender who provides the lending service, and may make the lender determine lending permission and inhibition based on the total score.

Recording Medium

In the embodiment, a program that can execute a processing method by the wallet server 10 or the user terminal 30 can be recorded on a recording medium that is readable by a computer or other machines or apparatuses (hereinafter, referred to as a computer or the like). The program on the recording medium is read to and executed on the computer or the like, whereby the computer or the like functions as the controller of the wallet server 10 or the user terminal 30. Here, the recording medium that is readable by the computer or the like refers to a non-transitory recording medium on which information, such as data or programs, can be accumulated by an electrical, magnetic, optical, mechanical, or chemical action and can be read through the computer or the like. Among such recording mediums, examples of recording mediums that are removable from the computer or the like include a flexible disk, a magneto-optical disk, a CD-ROM, a CD-R/W, a digital versatile disk (DVD), a BD, a DAT, a magnetic tape, and a memory card, such as a flash memory. Examples of recording mediums that are fixed in the computer or the like include a hard disk and a ROM. In addition, an SSD is available as a recording medium that is removable from the computer or the like or as a recording medium that is fixed in the computer or the like.

### OTHER EMBODIMENTS

In the wallet system 1 according to the embodiment, a “unit” can be replaced with a “circuit” or the like. For example, the communication unit can be replaced with a communication circuit.

The program that is executed by the wallet server 10 or the user terminal 30 according to the embodiment may be provided by storing the program on a computer connected to a network, such as the Internet, and downloading the program by way of the network.

Other effects or modification examples can be easily derived by those skilled in the art. Broader aspects of the present disclosure are not limited to specific details and representative embodiments shown and described above. Accordingly, various alterations may be made without departing from the spirit or scope of the general inventive concept defined by the appended claims and equivalent thereof.

What is claimed is:

1. An information processing apparatus comprising a processor having hardware,
wherein the processor is configured to
calculate a total score of a borrower who desires to use a lending service, based on a use record score determined by a use record of the borrower in the lending service and a credibility score determined by a payment record of each settlement means,
output the total score of the borrower to a terminal of a lender, and
output a lending permission and inhibition result to a terminal of the borrower according to response information acquired from the terminal of the lender.

2. The information processing apparatus according to claim 1, wherein the processor is configured to compare a lending permission and inhibition condition set by the lender with the total score of the borrower who desires to use the lending service to determine whether or not the lending permission and inhibition condition of the lending service in the lender is satisfied.

3. The information processing apparatus according to claim 1, wherein the processor is configured to perform setting for making the terminal of the borrower perform settlement with settlement means set by the lender.

4. The information processing apparatus according to claim 1, wherein the processor is configured to, when a response from the terminal of the lender is lending permission, output, to the terminal of the borrower, that the use of the lending service is permitted.

5. The information processing apparatus according to claim 1, wherein the processor is configured to, when a response from the terminal of the lender is lending inhibition, output, to the terminal of the borrower, that the use of the lending service is rejected.

6. The information processing apparatus according to claim 1, wherein the processor is configured to, based on a total score of each of a plurality of borrowers who desires to use the lending service and a lending permission and inhibition condition set by the lender who provides the lending service, select a borrower who uses the lending service.

7. The information processing apparatus according to claim 1, wherein the lending service is a service that lends a vehicle of the lender.

8. The information processing apparatus according to claim 7, wherein the use record score is determined by a driving history of the borrower and evaluation pertaining to use of the vehicle.

9. An information processing program causing a processor having hardware to execute
calculating a total score of a borrower who desires to use a lending service, based on a use record score determined by a use record of the borrower in the lending service and a credibility score determined by a payment record of each settlement means,
outputting the total score of the borrower to a terminal of a lender, and
outputting a lending permission and inhibition result to a terminal of the borrower according to response information acquired from the terminal of the lender.

10. The information processing program according to claim 9, causing the processor to execute comparing a lending permission and inhibition condition set by the lender with the total score of the borrower who desires to use the lending service to determine whether or not the lending permission and inhibition condition of the lending service in the lender is satisfied.

11. The information processing program according to claim 9, causing the processor to execute performing setting for making the terminal of the borrower perform settlement by settlement means set by the lender.

12. The information processing program according to claim 9, causing the processor to execute, when a response from the terminal of the lender is lending permission, outputting, to the terminal of the borrower, that the use of the lending service is permitted.

13. The information processing program according to claim 9, causing the processor to execute, when a response from the terminal of the lender is lending inhibition, outputting, to the terminal of the borrower, that the use of the lending service is rejected.

14. The information processing program according to claim 9, causing the processor to execute, based on a total score of each of a plurality of borrowers who desires to use the lending service and a lending permission and inhibition condition set by the lender who provides the lending service, selecting a borrower who uses the lending service.

15. An information processing system comprising:
a first terminal including a first processor having hardware, and a display;
a second terminal including a second processor having hardware, and a display; and
an information processing apparatus including a third processor having hardware, the third processor being configured to calculate a total score of a borrower who desires to use a lending service, based on a use record score determined by a use record of the borrower in the lending service and a credibility score determined by a payment record of each settlement means, output the total score of the borrower to a terminal of a lender, and output a lending permission and inhibition result to a terminal of the borrower according to response information acquired from the terminal of the lender.

16. The information processing system according to claim 15, wherein the third processor is configured to compare a lending permission and inhibition condition set by the lender who provides the lending service with the total score of the borrower who desires to use the lending service to determine whether or not the lending permission and inhibition condition of the lending service in the lender is satisfied.

17. The information processing system according to claim 15, wherein the third processor is configured to perform setting for making the second terminal perform settlement with settlement means set by the lender who provides the lending service.

18. The information processing system according to claim 15, wherein the third processor is configured to, when a response from the first terminal is lending permission, output, to the second terminal, that the use of the lending service is permitted.

19. The information processing system according to claim 15, wherein the third processor is configured to, when a response from the first terminal is lending inhibition, output, to the second terminal, that the use of the lending service is rejected.

20. The information processing system according to claim 15, wherein the third processor is configured to, based on a total score of each of a plurality of borrowers who desires to use the lending service and a lending permission and inhibition condition set by the lender who provides the lending service, select a borrower who uses the lending service.
